(19) United States
(12) Patent Application Publication
(10) Pub. No.: US 2025/0220760 A1
(43) Pub. Date: Jul. 3, 2025

(54) INFORMATION PROCESSING DEVICE AND STORAGE MEDIUM

(71) Applicant: TOYOTA JIDOSHA KABUSHIKI KAISHA, Toyota-shi (JP)

(72) Inventors: Takamasa HIGUCHI, Tokyo (JP); Jing MA, Yokohama-shi (JP); Xiao SHAO, Kawasaki-shi (JP); Lei ZHONG, Tokyo (JP)

(73) Assignee: TOYOTA JIDOSHA KABUSHIKI KAISHA, Toyota-shi (JP)

(21) Appl. No.: 18/901,364

(22) Filed: Sep. 30, 2024

(30) Foreign Application Priority Data
Dec. 27, 2023 (JP) 2023-221469

(51) Int. Cl. H04W 76/23

(52) U.S. Cl. CPC H04W 76/23

(57) ABSTRACT

An information processing device acquires a total number of second mobile bodies and third mobile bodies within a predetermined area, the second mobile bodies relays a data block between a first mobile body and a predetermined server through device-to-device communication with the first mobile body and through first wireless communication with the predetermined server, and the third mobile bodies relays the data block between the first mobile body and the second mobile bodies through the device-to-device communication. When the total number of second mobile bodies and third mobile bodies is less than a predetermined threshold value, the information processing device instructs either the second mobile bodies or the first mobile body to appoint a different mobile body as a third mobile body by transmitting the data block to the different mobile body through the device-to-device communication.

### CROSS-REFERENCE TO RELATED APPLICATION

This application claims priority to Japanese Patent Application No. 2023-221469 filed on Dec. 27, 2023, incorporated herein by reference in its entirety.

### BACKGROUND

### 1. Technical Field

The present disclosure relates to content distribution and data collection performed using device-to-device communication.

### 2. Description of Related Art

There is discloses a technique in which a plurality of pieces of data obtained by dividing a data content to be distributed is downloaded to a plurality of distribution vehicles through cellular communication or the like, and distributed through vehicle-to-vehicle communication when the distribution vehicles pass a reception vehicle that requires the content on a road (Maheswaran Sathiamoorthy, Alexandros G. Dimakis, Bhaskar Krishnamachari, Fan Bai, “Distributed Storage Codes Reduce Latency in Vehicular Networks”, IEEE Transactions on Mobile Computing, Jul. 30, 2014, vol. 13, no. 9, pp. 2016-2027, for example). The reception vehicle collects pieces of data received from one or more distribution vehicles, and performs a decoding process to restore the original data content.

### SUMMARY

An object of an aspect of the present disclosure is to provide an information processing device and a program capable of reducing the time required for content distribution or data collection performed using device-to-device communication between mobile bodies.

An aspect of the present disclosure provides
an information processing device including a control unit configured to: acquire a total number of second mobile bodies and third mobile bodies within a predetermined area, the second mobile bodies relaying a data block between a first mobile body and a predetermined server through device-to-device communication with the first mobile body and through first wireless communication with the predetermined server, and the third mobile bodies relaying the data block between the first mobile body and the second mobile bodies through the device-to-device communication; and
when the total number is less than a predetermined threshold value, instruct either the second mobile bodies or the first mobile body to appoint a different mobile body as a third mobile body by transmitting the data block to the different mobile body through the device-to-device communication.

Another aspect of the present disclosure provides
a storage medium storing a program that causes a computer to execute a process including: acquiring a total number of second mobile bodies and third mobile bodies within a predetermined area, the second mobile bodies relaying a data block between a first mobile body and a predetermined server through device-to-device communication with the first mobile body and through first wireless communication with the predetermined server, and the third mobile bodies relaying the data block between the first mobile body and the second mobile bodies through the device-to-device communication; and
when the total number is less than a predetermined threshold value, instructing either the second mobile bodies or the first mobile body to appoint a different mobile body as a third mobile body by transmitting the data block to the different mobile body through the device-to-device communication.

According to the present disclosure, it is possible to reduce the time required for content distribution or data collection performed using device-to-device communication between mobile bodies.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a system configuration of a content distribution system according to a first embodiment;

FIG. 2 is a diagram illustrating an example of a hardware configuration and a functional configuration of a distribution server and a distribution vehicle;

FIG. 3 is an example of a flowchart of processing performed by the number adjustment unit of the distribution server;

FIG. 4 is an example of a flowchart of processing in the relay vehicle appointment mode of the distribution control unit of the distribution vehicle;

FIG. 5 is an example of a flowchart of processing performed by the number adjustment unit of the distribution vehicle according to the second embodiment;

FIG. 6 is an example of a flowchart of processing in the relay vehicle appointment mode of the distribution control unit of the distribution vehicle according to the second embodiment;

FIG. 7 is a diagram illustrating an exemplary system configuration of the data collection system according to the third embodiment; and

FIG. 8 is a diagram illustrating an example of a functional configuration of a source vehicle.

### DETAILED DESCRIPTION OF EMBODIMENTS

In a system in which data contents are downloaded to a plurality of distribution vehicles through cellular communication or the like, and the data contents are distributed by vehicle-to-vehicle communication when the data contents are different from the reception vehicles, the data contents may be divided into pieces of fragmented data. In areas of low vehicle density and non-peak periods of low traffic volume, the receiving vehicle may encounter less opportunity with the delivery vehicle, and it may take time for the receiving vehicle to align all of the fragmented data needed to restore the data content.

On the other hand, there is a problem that it is difficult to easily increase the number of distribution vehicles. This is because, when the distribution vehicle downloads the fragment data through the cellular communication, the bandwidth use and the communication cost of the cellular communication network increase as the distribution vehicle increases. Downloading of fragmented data through WiFi communication can reduce communication costs, but is limited to battery electric vehicle that are being charged and the like, which are less likely to deplete the on-board battery.

In view of the above-described problem, in one embodiment of the present disclosure, when the number of distribution vehicles of a predetermined content is small in a predetermined area, the number of vehicles that distribute the fragment data to the reception vehicle in the inter-vehicle communication is increased as in the case of the distribution vehicle. The vehicle receives the fragment data from the distribution vehicle through the inter-vehicle communication, instead of the vehicle operating as the distribution vehicle, and distributes the fragment data to the reception vehicle through the inter-vehicle communication in the same manner as the distribution vehicle. Accordingly, it is possible to increase the number of vehicles that distribute the fragment data to the receiving vehicle through the inter-vehicle communication without using the cellular communication network. Therefore, the receiving vehicle has an increased opportunity to receive the fragment data through the inter-vehicle communication, and can shorten the time required for the receiving vehicle to align all the fragment data necessary for restoring the data content.

More specifically, one embodiment of the present disclosure is an information processing device including a control unit. The control unit is configured to acquire the total number of the second moving object and the third moving object in a predetermined area. In addition, when the total number is less than the predetermined threshold value, the control unit instructs either one of the second mobile object or the first mobile object to transmit a data block to the other mobile object through inter-device communication and to appoint the other mobile object to the third mobile object. The second mobile unit relays a data block between the first mobile unit and the predetermined server through device-to-device communication with the first mobile body and the first wireless communication with the predetermined server. The third mobile unit relays the data block between the first mobile unit and the second mobile unit through device-to-device communication.

The information processing device is, for example, a server that controls a distribution vehicle in a content distribution system that causes the distribution vehicle to distribute the content to a receiving vehicle through inter-vehicle communication. Alternatively, the information processing device is, for example, an in-vehicle apparatus mounted on a source vehicle in a data collection system that causes the sink vehicle to collect data generated by the source vehicle through inter-vehicle communication. Alternatively, the information processing device may be, for example, an in-vehicle device mounted on the distribution vehicle in the content distribution system or a server that collects data in the data collection system. However, the information processing device is not limited thereto, and may be, for example, a computer mounted on a mobile object other than vehicles, and a mobile terminal such as a smart phone, a tablet terminal, and a Personal Computer (PC). The control unit is, for example, a processor such as Central Processing Unit (CPU), Graphics Processing Unit (GPU), and Digital Signal Processor (DSP). However, the control unit is not limited to the processor, and may be, for example, a Field Programmable Gate Array (FPGA), Integrated Circuit (IC), Complex Programmable Logic Device (CPLD), or the like.

The moving body includes, for example, a vehicle such as an automobile, a motorcycle, and a railroad, a ship, an aircraft, and the like. Further, the mobile object may include, for example, a smart phone, a tablet terminal, a PC, a portable game machine, and the like. In the content distribution system, for example, the first mobile object is a receiving vehicle and the second mobile object is a distribution vehicle. In a data collection system, for example, the first vehicle is a source vehicle and the second vehicle is a sink vehicle. The predetermined area is, for example, a grid of a predetermined length, a predetermined range defined in accordance with a road shape, or the like.

The data block is, for example, a distribution content body, fragment data of the distribution content, a data body to be collected, or fragment data of the data to be collected.

The first radio communication is, for example, communication by a cellular communication system such as 5th Generation (5G), 6G, 4G, or communication by WiFi communication. However, the first wireless communication is not limited thereto. The inter-device communication is, for example, a communication method capable of inter-terminal communication such as inter-vehicle radio LAN communication, Dedicated Short-Range Communications (DSRC), 5G sidelink communication, Device-to-Device (D2D) communication, and ad hoc mode WiFi communication. However, the inter-device communication is not limited thereto.

According to one aspect of the present disclosure, when the total number of the second moving object and the third moving object in the predetermined area is less than the predetermined value, the other moving object is designated as the third moving object, and the number of the third moving objects is increased. For example, in a content distribution system, the number of vehicles that transmit data blocks to a receiving vehicle, which is a first mobile object, by device-to-device communication increases. Therefore, the receiving vehicle has an increased opportunity to receive the data block and can shorten the time until the content is acquired. For example, in the data collection system, since the number of vehicles that receive the data block from the source vehicle, which is the first mobile unit, through the device-to-device communication increases, it is possible to shorten the time required for collecting the data block generated by the source vehicle.

In one aspect of the present disclosure, the control unit may further perform determining a predetermined threshold based on at least one of a position, a time zone, and a traffic volume of the predetermined area. Accordingly, it is possible to set a threshold value corresponding to the actual state of the traffic amount in the area, and it is possible to adjust the total number of the second moving object and the third moving object in the area to a number suitable for the actual state of the traffic amount in the area.

According to another aspect of the present disclosure, it is possible to specify a method in which a computer executes a process executed by the information processing device, a program for causing a computer to execute the method, and a non-transitory computer-readable recording medium in which the program is recorded.

Hereinafter, embodiments of the present disclosure will be described with reference to the drawings. The configurations of the following embodiments are illustrative, and the present disclosure is not limited to the configurations of the embodiments.

### First Embodiment

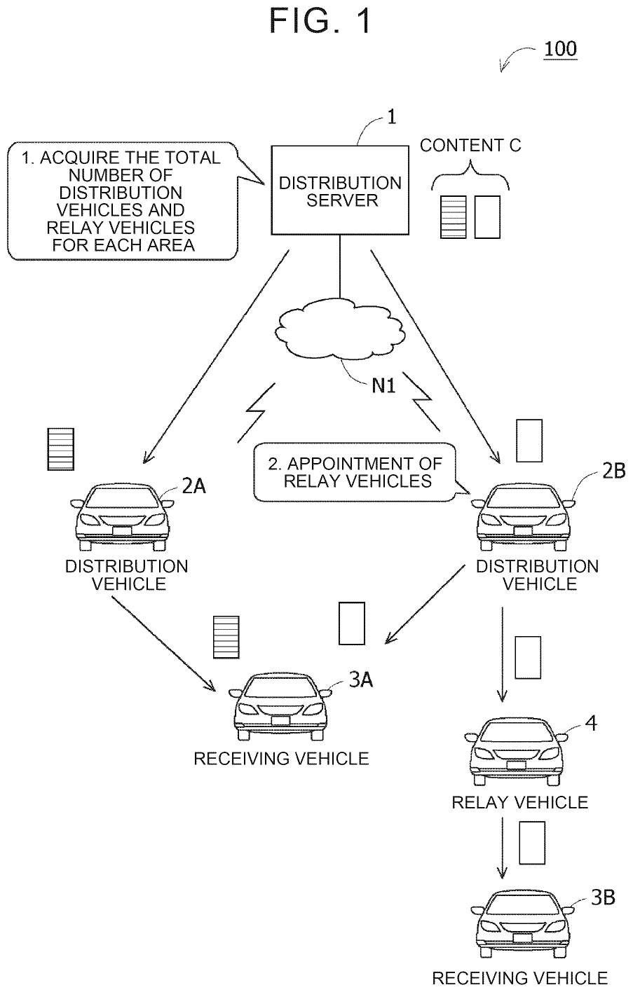

FIG. 1 is a diagram showing an example of the system configuration of a content distribution system 100 according to a first embodiment. The content distribution system 100 is a system that distributes predetermined content to some vehicles by inter-vehicle communication to other vehicles. The content distribution system 100 includes a distribution server 1, a distribution vehicle 2, and a reception vehicle 3. Further, in the first embodiment, the content distribution system 100 also includes a relay vehicle 4 that relays content between the distribution vehicle 2 and the reception vehicle 3 through inter-vehicle communication. In practice, the content distribution system 100 may include a plurality of distribution vehicles 2, a plurality of reception vehicles 3, and a plurality of relay vehicles 4. Unless otherwise specified, the vehicle is simply referred to as a distribution vehicle 2, a reception vehicle 3, and a relay vehicle 4. In the first embodiment, each vehicle is equipped with an in-vehicle device having a communication function. In the following description, communication regarding each vehicle is mainly performed by each vehicle, although the actual subject is an in-vehicle device mounted on the vehicle.

The distribution server 1 and the vehicles are connected to a network N1 and can communicate with each other via a network N1. The network N1 is, for example, a public network such as the Internet. The vehicles can be connected to a network N1 via a cellular network or a radio LAN as an access network.

The distribution server 1 is a server that holds the original data of the content to be distributed to the vehicle, selects the distribution vehicle 2, and transmits the content to the distribution vehicle 2. The distribution server 1 may divide the content into pieces of data and transmit the pieces of data to the distribution vehicle 2. Fragment data may be generated using encoding techniques such as erasure correction codes. The distribution vehicle 2 downloads the fragment data from the distribution server 1 through cellular communication or WiFi communication, stores the fragment data in the storage of the in-vehicle device, and transmits the fragment data in the reception vehicle through the inter-vehicle communication when it passes the reception vehicle 3. The distribution vehicle 2 itself may or may not be the reception vehicle 3 that is the distribution destination of the content. In the first embodiment, the inter-vehicle communication may be, for example, any of inter-vehicle radio LAN communication, DSRC, or 5G sidelink communication.

The reception vehicle 3 is a vehicle to which content is distributed. The reception vehicles 3 receive a content obtaining instruction from the distribution server 1 through cellular communication or WiFi communication. Thereafter, when the reception vehicle 3 is different from the distribution vehicle 2 on the road, when the distribution vehicle 2 holds the fragmentary data specified by the content acquisition instruction, through the vehicle-to-vehicle communication, to acquire the unheld fragmentary data from the distribution vehicle 2. When the reception vehicle 3 acquires the number of pieces of fragment data that can restore the content C, it restores the content C using, for example, the decryption information included in the content acquisition instruction from the distribution server 1.

The relay vehicle 4 is appointed when passing through the distribution vehicle 2, receives the fragment data through the inter-vehicle communication, and transmits the fragment data to the reception vehicle 3 through the inter-vehicle communication when passing through the reception vehicle 3. The relay vehicle 4 may or may not be the reception vehicle 3 that is the distribution destination of the content.

In the first embodiment, the distribution server 1 acquires, for each area, the total number of the distribution vehicles 2 and the relay vehicles 4 that distribute the content C. When the total number of the distribution vehicles 2 and the relay vehicles 4 distributing the content C in the area is less than the threshold value N, the distribution server 1 determines to increase the number of the relay vehicles 4, and transmits an appointment start instruction of the relay vehicles to each distribution vehicle 2.

Upon receiving the appointment start instruction of the relay vehicle, the distribution vehicle 2 transmits the fragment data to the passing vehicle by inter-vehicle communication, and appoints the fragment data to the relay vehicle. When the vehicle is designated as a relay vehicle, the relay vehicle 4 transmits the fragment data in the inter-vehicle communication when the vehicle is passed with the reception vehicle 3. This increases the number of vehicles transmitting the fragment data to the reception vehicle 3, so that it is possible to shorten the time required for the reception vehicle 3 to acquire all the fragment data necessary for restoring the original content C.

The fragment data is an example of a “data block”. The reception vehicle 3 is an example of a “first moving body”. The distribution vehicle 2 is an example of a “second moving body”. The relay vehicle 4 is an example of a “third moving body”. The inter-vehicle communication is an example of “inter-device communication”. The distribution server 1 is an example of an “information processing device”. In the following description, when two vehicles pass each other, it is assumed that not only the two vehicles pass each other but also the two vehicles are capable of inter-vehicle communication.

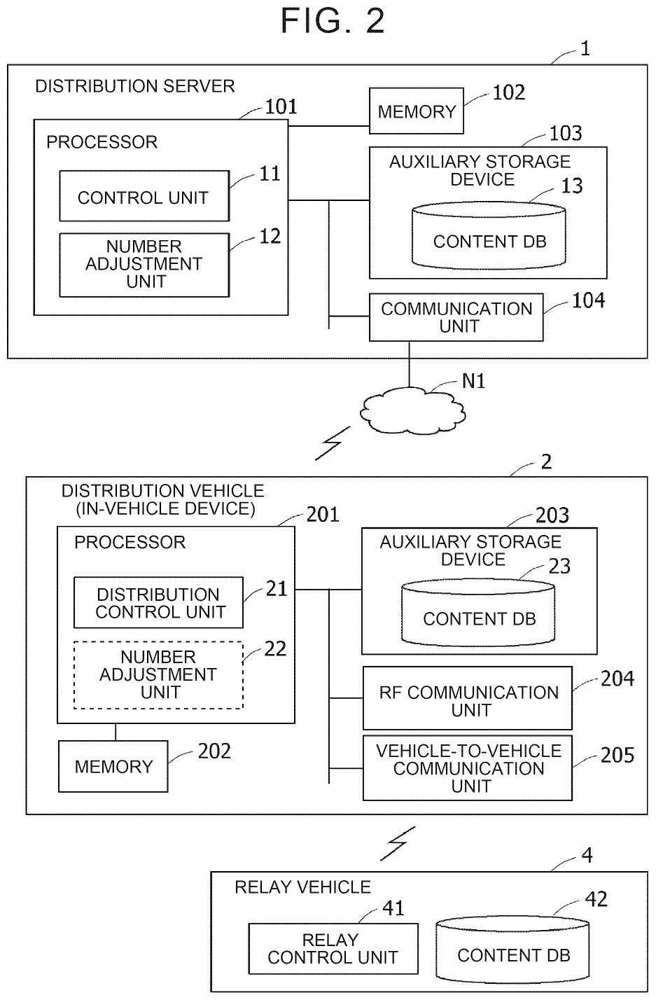

FIG. 2 is a diagram illustrating an example of a hardware configuration and a functional configuration of the distribution server 1 and the distribution vehicle 2. First, the hardware configurations of the distribution server 1 and the distribution vehicle 2 will be described. The distribution server 1 can be configured using an information processing device (computer) such as a server machine. The distribution server 1 may be a collection (cloud) of one or more computers. It should be noted that the distribution server 1 may be devices including electric circuits such as dedicated Field-Programmable Gate Array (FPGA) or Application Specific Integrated Circuit (ASIC) for executing the corresponding processes.

The distribution server 1 includes a processor 101, a memory 102, an auxiliary storage device 103, and a communication unit 104 as a hardware configuration. The memory 102 and the auxiliary storage device 103 are computer-readable recording media. The auxiliary storage device 103 is, for example, Erasable Programmable ROM (EPROM), Hard Disk Drive, or Solid State Drive (SSD). The programs held in the auxiliary storage device 103 include, for example, an operating system (OS), a control program of the content distribution system 100, and the like. The memory 102 includes, for example, a solid-state memory such as Read Only Memory (ROM), Random Access Memory (RAM).

The processor 101 is, for example, a CPU, GPU, or a Digital Signal Processor (DSP). The number of processors 101 is not limited to one, and a plurality of processors may be provided. The processor 101 is an example of a “control unit”.

The communication unit 104 is, for example, a Network Interface Card (NIC), an optical line interface, or the like. The communication unit 104 may be, for example, a wireless communication circuit connected to a wireless network such as a wireless LAN.

The distribution vehicle 2 includes an in-vehicle device. The hardware configuration of the distribution vehicle 2 illustrated in FIG. 2 is a hardware configuration of an in-vehicle device. The in-vehicle device of the distribution vehicle 2 is, for example, a Data Communication Module, a car navigation system, a drive recorder, or the like. The in-vehicle device includes a processor 201, a memory 202, an auxiliary storage device 203, a wireless communication unit 204, and an inter-vehicle communication unit 205 as a hardware configuration. The processor 201, the memory 202, and the auxiliary storage device 203 are the same as those of the processor 101, the memory 102, and the auxiliary storage device 103. However, the auxiliary storage device 203 stores, in addition to OS and the like, a control program for controlling the operation as the distribution vehicle 2.

The wireless communication unit 204 is, for example, a wireless communication circuit corresponding to a mobile communication method such as 5G, 4G or 6G, or a wireless communication method such as WiFi. The inter-vehicle communication unit 205 is, for example, a wireless communication circuit corresponding to an inter-vehicle communication system such as inter-vehicle wireless LAN communication, DSRC, or 5G sidelink communication. Note that the hardware configurations of the distribution server 1 and the in-vehicle device are not limited to those illustrated in FIG. 2. The in-vehicle device mounted on the reception vehicle 3 and the relay vehicle 4 also has the same hardware configuration as that of the in-vehicle device of the distribution vehicle 2 shown in FIG. 2.

Next, functional configurations of the distribution server 1, the distribution vehicle 2, and the relay vehicle 4 will be described. The distribution server 1 includes a control unit 11, a number adjustment unit 12, and a content DB 13 as a functional configuration. The control unit 11, the number adjustment unit 12, and the content DB 13 are functional components achieved by, for example, the processor 101 of the distribution server 1 executing a control program of the content distribution system 100. However, the present disclosure is not limited thereto, and the control unit 11, the number adjustment unit 12, and the content DB 13 may be realized by hardware components such as a FPGA. The same applies to functional components included in other apparatuses.

The content DB 13 holds the original data of the distribution content. The content DB 13 is created in a storage area of the auxiliary storage device 103.

The control unit 11 generates fragment data, selects and appoints the distribution vehicle 2, and transmits a content acquisition instruction to the reception vehicle 3. For example, the control unit 11 selects the distribution vehicle 2 from the vehicles managed by the content distribution system 100 in accordance with a predetermined rule.

The control unit 11 notifies the distribution vehicle 2 that the distribution vehicle has been selected, for example, by transmitting a message of notification of the appointment of the distribution vehicle or by pushing and transmitting the fragment data to the distribution vehicle. The control unit 11 identifies the reception vehicle 3 based on the content to be distributed, and transmits a content acquisition instruction to the reception vehicle 3. The content acquisition instruction includes, for example, identification information and decoding information of each piece of data to be acquired by the reception vehicle 3. The decryption information is information used to restore the original content from the fragment data. The decoding information is, for example, a decoding parameter, a checksum for confirming consistency with the original content, or the like. For example, when the fragment data is generated by the erasure correction code, the decoding parameter includes the number of pieces of fragment data necessary for restoring the original content, and the like.

The number adjustment unit 12 adjusts the number of the distribution vehicles 2 and the relay vehicles 4 of each content being distributed for each area. The area is, for example, an area such as a grid of a predetermined length or an area defined by a predetermined width according to the shape of the road. The area can be arbitrarily set by an administrator of the content distribution system 100.

The number adjustment unit 12 grasps the distribution status of each content for each area on the basis of the communication history information with the distribution vehicle 2 and the relay vehicle 4. For example, it is conceivable that the control unit 11 acquires a list of the position information and the fragment data held from the distribution vehicles 2 at a timing at which the fragment data is transmitted to the distribution vehicle 2 through cellular communication or WiFi communication. In this case, the number adjustment unit 12 may use these pieces of information as communication history information. Alternatively, the distribution vehicle 2 and the relay vehicle 4 may be caused to notify the distribution server 1 of the current position, the list of retained fragment data, and the transmission history information of the fragment data to other vehicles at a predetermined cycle or when a predetermined event occurs. The transmission history information of the fragment data to the other vehicle includes, for example, identification information of the vehicle of the transmission destination, a time stamp, a transmission position, and the like. An event that triggers transmission of the information from the distribution vehicle 2 and the relay vehicle 4 is, for example, transmission of fragment data to another vehicle. Further, other events are, for example, a change due to addition or deletion of fragment data in a list of pieces of fragment data to be held, and an appointment of another vehicle to a relay vehicle or an appointment of the other vehicle to a relay vehicle. The number adjustment unit 12 may use, as the communication history information, the list of the current position and the fragment data held and the transmission history information of the fragment data received from the distribution vehicle 2 or the relay vehicle 4 to the other vehicle.

The number adjustment unit 12 acquires the total number of the distribution vehicles 2 and the relay vehicles 4 for each content in each area on the basis of the communication history information about the distribution vehicles 2 and the relay vehicles 4. For the content of interest in the area, the total number of distribution vehicles 2 and relay vehicles 4 may be less than the threshold value N. In this case, the number adjustment unit 12 transmits, to the distribution vehicle 2 distributing the target content in the area, an appointment start instruction of the relay vehicle instructing the appointment start of the relay vehicle for the target content. In addition to the designation start instruction of the relay vehicle, the number of relay vehicles designated by the distribution vehicle 2 may also be notified to the distribution vehicle 2. Further, the number adjustment unit 12 may designate a time for the distribution vehicle 2 and the relay vehicle 4 to hold the fragment data of the target content on the in-vehicle storage, and transmit the designated time to the distribution vehicle 2 together with the designation start instruction of the relay vehicle. As a result, the fragment data of the target content is deleted from the in-vehicle storage of the distribution vehicle 2 and the relay vehicle 4 after the lapse of the specified time after being held from the in-vehicle storage.

For each content in each area, the total number of the distribution vehicle 2 and the relay vehicle 4 is monitored, and the total number of the distribution vehicle 2 and the relay vehicle 4 may be equal to or larger than the threshold value N. In this case, the number adjustment unit 12 transmits, to each distribution vehicle 2 that is distributing the target content in the area, an appointment stop instruction of the relay vehicle instructing the stop of the appointment of the relay vehicle with respect to the target content. As a result, an increase in the number of relay vehicles in the area is stopped.

In addition, the number adjustment unit 12 may determine the threshold value N of the total number of the distribution vehicles 2 and the relay vehicles 4 in each area. For example, in a case where the number of distribution vehicles 2 in each area is determined according to the vehicle density, in an area where the vehicle density is high, there are many distribution vehicles 2, and there are many opportunities for the reception vehicle 3 to pass the distribution vehicle 2. On the other hand, in an area where the vehicle density is low, the number of distribution vehicles 2 is small, and there is little opportunity for the reception vehicle 3 to pass the distribution vehicle 2. The vehicle density also varies depending on a time zone such as commuting time. Vehicle density also varies due to sudden events. Therefore, the number adjustment unit 12 may determine the threshold value N based on any one or a combination of, for example, the location of the area, the time zone, the traffic volume, and the like. For example, the N is set to be larger as the location of the area is larger. For example, in a time zone in which the traffic volume increases, such as a commuting time, N is set larger than the other time zones. For example, N is set larger as the traffic volume increases. Note that N is a number equal to or greater than the number of distribution vehicles 2 in the area. The threshold value N may be set using, for example, a predetermined function or a machine learning model. The threshold value N may be set according to the content. The higher the importance level of the content, the larger the threshold value N may be set.

As a result, the total number of the distribution vehicles 2 and the relay vehicles 4 that distribute the target content in the area can be appropriately adjusted, for example, in accordance with the variation of the vehicle density in the area. However, the present disclosure is not limited thereto, and the threshold value N may be a predetermined value (constant) in each area.

Next, the distribution vehicle 2 includes a distribution control unit 21 and a content DB 23 as a functional configuration. In FIG. 2, the number adjustment unit 22 is also described, but the number adjustment unit 22 is not provided in the distribution vehicle 2 in the first embodiment, but is provided in the distribution vehicle 2 in the second embodiment. The number adjustment unit 22 will be described in the second embodiment described later. The processing performed by these functional components is achieved, for example, by the processor 201 of the in-vehicle device of the distribution vehicle 2 executing a predetermined program held in the auxiliary storage device 203.

The content DB 23 is created in a storage area of the auxiliary storage device 203. The content DB 23 holds fragmented data acquired from the distribution server 1.

The distribution control unit 21 acquires fragment data from the distribution server 1 and distributes the fragment data to the reception vehicle 3. In a case where the notification of the appointment of the distribution vehicle is made by the message of the notification of the appointment of the distribution vehicle, the distribution control unit 21 downloads the distribution server 1, for example, based on the information of the piece data to be acquired received from the distribution server 1. As a result, the distribution control unit 21 acquires fragment data. For example, in a case where the notification of the appointment of the distribution vehicle is performed by the push transmission of the fragment data, the distribution control unit 21 may acquire the fragment data by receiving the fragment data through the push transmission from the distribution server 1. The distribution control unit 21 stores the fragmented data acquired from the distribution server 1 in the content DB 23.

The distribution control unit 21 distributes the fragment data to the reception vehicle 3. More specifically, the distribution control unit 21 transmits a list of pieces of data held in the content DB 23 to the reception vehicle 3 through the inter-vehicle communication when the pieces of data pass the reception vehicle 3. The reception vehicle 3 transmits an acquisition request to the distribution vehicle 2 for the unheld fragment data when the unheld fragment data is in the list received from the distribution vehicle 2. The distribution control unit 21 reads the fragment data requested from the reception vehicle 3 from the content DB 23, and transmits the fragment data to the reception vehicle 3 through the inter-vehicle communication. For example, when a designated time for holding fragment data is received from the distribution server 1 together with the fragment data, the distribution control unit 21 may delete the fragment data from the content DB 23 when the designated time has elapsed. After deleting the fragment data, the distribution control unit 21 may transmit a list of the time stamp, the current position, and the fragment data to be held to the distribution server 1.

Upon receiving the designation start instruction of the relay vehicle from the distribution server 1, the distribution control unit 21 starts the operation of the relay vehicle designation mode. In the relay vehicle appointment mode, when the passing vehicle satisfies the requirements of the relay vehicle, the distribution control unit 21 transmits the fragment data of the target content and the notification of the appointment of the relay vehicle, regardless of whether the vehicle is a vehicle that desires to distribute the target content, and appoints the vehicle to the relay vehicle. The requirement of the relay vehicle is, for example, that the remaining amount of in-vehicle storage is equal to or greater than a predetermined threshold value, and that the relay vehicle is a distribution vehicle or a relay vehicle having the same fragment data. However, the requirement of the relay vehicle is not limited thereto. Information used to determine whether or not the requirements of the relay vehicle, such as the remaining amount of in-vehicle storage, are satisfied is received from the counterpart vehicle by inter-vehicle communication. The distribution control unit 21 may transmit the fragment data as well as the designated time for the relay vehicle 4 to hold the fragment data. Upon receiving an appointment stop instruction of the relay vehicle from the distribution server 1, the distribution control unit 21 ends the relay vehicle appointment mode and returns to the normal mode. In the normal mode, the number adjustment unit 12 transmits fragment data to the passing reception vehicle 3, and does not appoint a relay vehicle.

The distribution control unit 21 may transmit the list of the time stamp, the current position, and the fragment data to be held to the distribution server 1 at a predetermined cycle. In addition, when the fragment data is transmitted to the reception vehicle 3 and when the relay vehicle 4 is designated as the relay vehicle, the distribution report may be transmitted to the distribution server 1. The distribution report includes, for example, a time stamp of the distributed time, position information at the distributed time, identification information of the distributed fragment data, identification information of the vehicle of the distribution destination, and information indicating the presence or absence of the appointment of the relay vehicle. The distribution report including the information indicating the appointment of the relay vehicle is an example of the “first notification”.

Next, the relay vehicle 4 includes a relay control unit 41 and a content DB 42 as a functional configuration. The relay control unit 41 is achieved by the processor of the in-vehicle device of the relay vehicle 4 executing a predetermined program held in the auxiliary storage device. When passing through the distribution vehicle 2, the relay control unit 41 receives the notification of the appointment of the relay vehicle and the fragment data from the distribution vehicle 2, and stores the fragment data in the content DB 42. Thereafter, the relay control unit 41 transmits the fragment data to the reception vehicle 3 in the same manner as the distribution vehicle 2 when passing the reception vehicle 3. Similar to the distribution vehicle 2, the relay control unit 41 may transmit the list of the time stamp, the current position, and the fragment data to be held to the distribution server 1 at a predetermined cycle. Similarly to the distribution vehicle 2, the relay control unit 41 may transmit the distribution report to the distribution server 1 when the fragment data is transmitted to the reception vehicle 3. When the designated time for holding the fragment data is received together with the notification of the appointment of the relay vehicles and the fragment data, the relay control unit 41 deletes the corresponding fragment data from the content DB 42 after the designated time has elapsed. After deleting the fragment data, the relay control unit 41 may transmit a list of the time stamp, the current position, and the fragment data to be held to the distribution server 1.

The content DB 42 is created in a storage area in the auxiliary storage device of the in-vehicle device of the relay vehicle 4. The content DB 42 stores fragmented data received from the distribution vehicles 2. Note that the functional configurations of the distribution server 1, the distribution vehicle 2, and the relay vehicle 4 shown in FIG. 2 are examples, and the functional configurations of the distribution server 1, the distribution vehicle 2, and the relay vehicle 4 are not limited to the examples shown in FIG. 2.

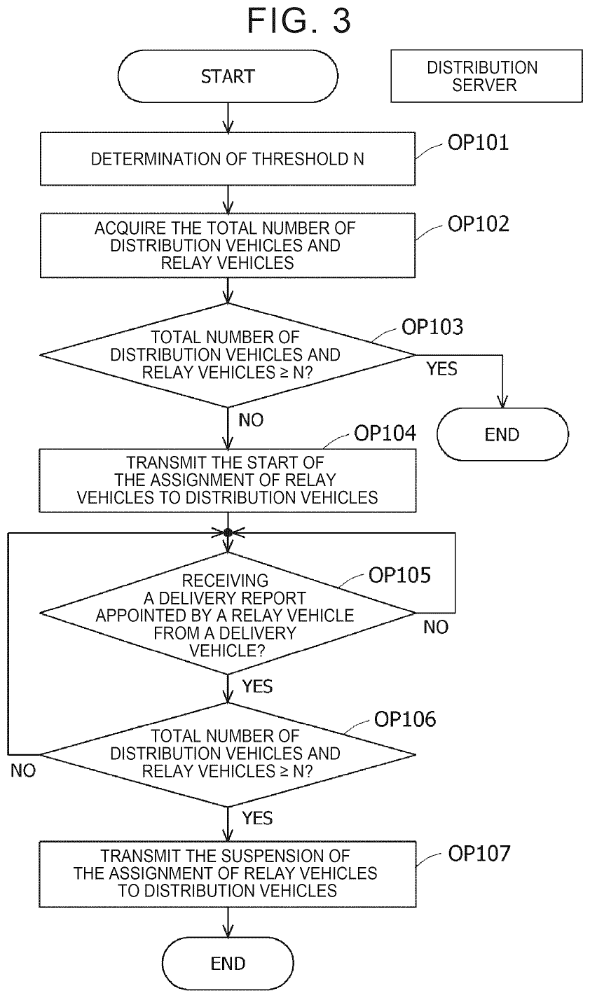

FIG. 3 is an example of a flowchart of processing performed by the number adjustment unit 12 of the distribution server 1. The processing illustrated in FIG. 3 is repeatedly executed, for example, at a predetermined cycle in units of one hour to several hours designated by an administrator of the content distribution system 100 or at a timing designated by an administrator of the content distribution system 100. Further, the processing illustrated in FIG. 3 is executed for each content being distributed in each area. The execution subject of the processing illustrated in FIG. 3 is, for example, the processor 101 of the in-vehicle device of the distribution server 1, but for convenience, the functional components will be mainly described.

In OP101, the number adjustment unit 12 determines the threshold value N of the total number of the distribution vehicles 2 and the relay vehicles 4 distributing the target content within the target area on the basis of, for example, the position, the time zone, the traffic volume, and the like of the target area.

In OP102, the number adjustment unit 12 acquires the total number of the distribution vehicles 2 and the relay vehicles 4 distributing the target content in the target area on the basis of the communication history information with the distribution vehicles 2 and the relay vehicles 4 in the latest predetermined period. The number of distribution vehicles 2 in the target area is the same regardless of the content being distributed at the same time. On the other hand, the number of the relay vehicles 4 in the target area is different for each content being distributed at the same time.

In OP103, the number adjustment unit 12 determines whether or not the total number of the distribution vehicles 2 and the relay vehicles 4 acquired by OP102 is equal to or greater than the threshold value N. When the total number of the distribution vehicles 2 and the relay vehicles 4 is equal to or greater than the threshold value N (OP103: YES), since there are already enough distribution vehicles 2 and relay vehicles 4 in the target area, the process illustrated in FIG. 3 ends. When the total number of the distribution vehicles 2 and the relay vehicles 4 is less than the threshold value N (OP103: NO), the process proceeds to OP104. In OP104, the number adjustment unit 12 transmits an instruction to start appointment of the relay vehicle for the target content to the distribution vehicles 2 that distribute the target content within the target area.

In OP105, the number adjustment unit 12 determines whether or not a distribution report including the assignment of the relay vehicle has been received for the target content from the distribution vehicle 2 in the target area. When the distribution report including the information indicating that the relay vehicle has been appointed for the target content is received from the distribution vehicle 2 in the target area (OP105: YES), the number adjustment unit 12 updates the total number of the distribution vehicles 2 and the relay vehicles 4 distributing the target content in the target area, and the process proceeds to OP106. When the distribution report including the information indicating that the relay vehicle has been appointed is not received from the distribution vehicle 2 in the target area (OP105: NO), the number adjustment unit 12 is in a standby state.

In OP106, the number adjustment unit 12 determines whether or not the total number of the updated distribution vehicles 2 and the relay vehicles 4 is equal to or greater than the threshold value N. When the total number of the distribution vehicles 2 and the relay vehicles 4 is less than the threshold value N (OP106: NO), the process proceeds to OP105. When the total number of the distribution vehicle 2 and the relay vehicle 4 is equal to or larger than the threshold value N (OP106: YES), the process proceeds to OP107. In OP107, the number adjustment unit 12 transmits an appointment stopping instruction of the relay vehicle for the target content to the distribution vehicle 2 that distributes the target content in the target area. Thereafter, the process illustrated in FIG. 3 is ended.

When the processing of FIG. 3 is newly started for the target content of the target area, the processing of FIG. 3 being executed is terminated by, for example, the processing of OP105 and OP106. Note that the processing of the number adjustment unit 12 is not limited to the processing illustrated in FIG. 3.

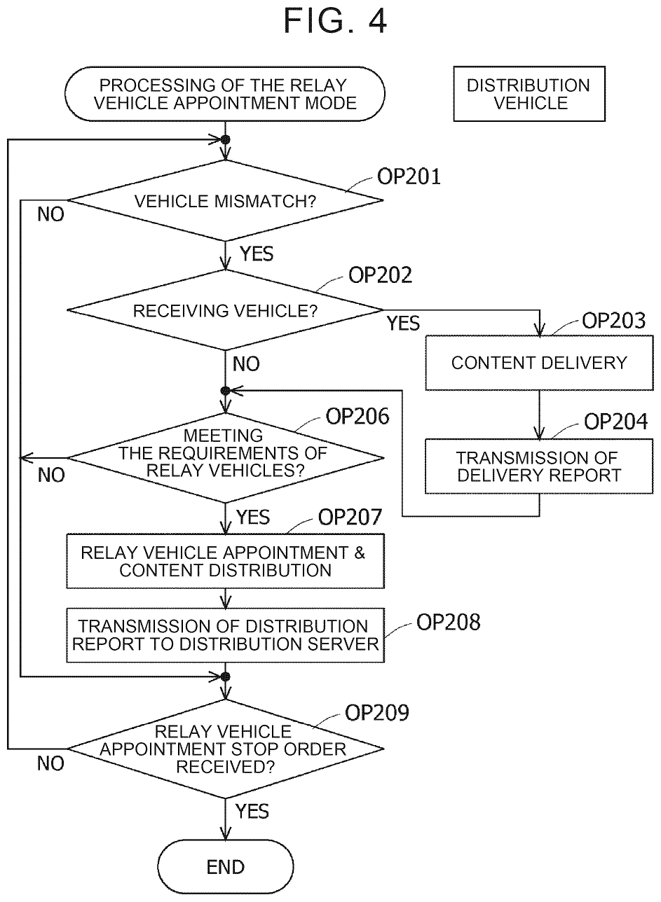

FIG. 4 is an example of a flowchart of processing in the relay vehicle appointment mode performed by the distribution control unit 21 of the distribution vehicle 2. The process illustrated in FIG. 4 is started when the distribution control unit 21 receives an appointment start instruction of the relay vehicle from the distribution server 1. The execution subject of the processing illustrated in FIG. 4 is, for example, the processor 201 of the in-vehicle device of the distribution vehicle 2, but for convenience, the functional components will be mainly described. The same applies to the flowchart of the distribution vehicle 2 described below.

In OP201, the distribution control unit 21 determines whether or not it has passed other vehicles. If the vehicle has passed the other vehicle (OP201: YES), the process proceeds to OP202. If the vehicle has not passed other vehicles (OP201: NO), the process proceeds to OP209.

In OP202, the distribution control unit 21 determines whether or not the passing vehicle is the reception vehicle 3. If the passing vehicle is the reception vehicle 3 (OP202: YES), the process proceeds to OP203. In OP203, the distribution control unit 21 transmits the requested fragment data to the reception vehicle 3 through vehicle-to-vehicle communication. In OP204, the distribution control unit 21 transmits a distribution report of the fragmented data to the reception vehicles 3 to the distribution server 1. Thereafter, the process proceeds to OP 206.

If the passing vehicle is not the reception vehicle 3 (OP202: NO), the process proceeds to OP206. In OP206, the distribution control unit 21 determines whether the passing vehicle satisfies the requirement of the relay vehicle. If the passing vehicle meets the requirements of the relay vehicle (OP206: YES), the process proceeds to OP207. If the passing vehicle does not meet the requirements of the relay vehicle (OP206: NO), the process proceeds to OP209.

In OP207, the distribution control unit 21 sends to a different vehicle a notice of appointment of the intermediary vehicle and pieces of content subject to the intermediary vehicle appointment in inter-vehicle communications. In OP208, the distribution control unit 21 sends pieces of content subject to the transfer vehicle appointment to the distribution server 1 and sends a distribution report including information showing the transfer vehicle appointment.

In OP209, the distribution control unit 21 determines whether or not an appointment stopping instruction for the relay vehicles has been received from the distribution server 1. When an appointment stopping instruction for the relay vehicle is received from the distribution server 1 (OP209: YES), the process illustrated in FIG. 4 ends, and the distribution control unit 21 returns to the normal mode. When an appointment stopping instruction for the relay vehicles has not been received from the distribution server 1 (OP209: NO), the process proceeds to OP201. Note that the processing of the distribution control unit 21 is not limited to the processing illustrated in FIG. 4.

### Action Effect of First Embodiment

In the first embodiment, for the content in which the total number of the distribution vehicles 2 and the relay vehicles 4 in the area is less than the threshold value N, the number of the relay vehicles 4 that distribute the target content to the reception vehicle 3 is increased through the distribution vehicle 2 that is distributing the target content in the area. As a result, the chance of distributing the fragment data of the target content to the reception vehicle 3 increases, and the time until the reception vehicle 3 acquires the target content can be shortened.

In the first embodiment, the fragment data as well as the fragment data are also transmitted to the distribution vehicle 2 or the relay vehicle 4 for a specified time in which the fragment data is held in the distribution vehicle 2 or the relay vehicle 4. As a result, in the distribution vehicle 2 or the relay vehicle 4, the fragment data is deleted from the in-vehicle storage after the specified time. Therefore, when a sufficient amount of time has elapsed for the content to reach the reception vehicle 3 in the area, the number of the relay vehicles 4 that distribute the content naturally decreases, and the total number of the distribution vehicles 2 and the relay vehicles 4 in the area can be adjusted.

### Modification of the First Embodiment

In the first embodiment, the distribution control unit 21 of the distribution vehicle 2 appoints a different vehicle on the road to the relay vehicle 4 from the reception of the appointment start instruction of the relay vehicle until the reception of the appointment stop instruction of the relay vehicle. In the case of this method, the number of relay vehicles 4 can be increased more quickly. However, the following methods can be applied to the method of appointing the relay vehicle of the distribution vehicle 2 in addition to the above.

### Method 1 for Appointing Relay Vehicle

After appointing one vehicle to the relay vehicle 4, the distribution control unit 21 suppresses the appointment of the next relay vehicle until a predetermined condition is satisfied. The predetermined condition is, for example, that the elapsed time from the appointment of the previous relay vehicle reaches a predetermined threshold value, or that the travel distance from the appointment point of the previous relay vehicle exceeds the predetermined threshold value. As a result, the relay vehicle 4 can be distributed over a wider range.

### Method 2 for Appointing a Relay Vehicle

When it is assumed that the other vehicle runs in parallel with the own distribution vehicle 2, the distribution control unit 21 excludes the other vehicle from the candidate of the relay vehicle. For example, the distribution control unit 21 may determine the possibility of parallel travel by acquiring a future scheduled travel route of the other vehicle from the other vehicle by inter-vehicle communication and comparing the scheduled travel route of the own distribution vehicle 2 with the scheduled travel route of the other vehicle. Alternatively, the distribution control unit 21 may determine the possibility of parallel running based on the similarity between the moving direction and the speed of the host distribution vehicle 2 and the other vehicle.

### Method 3 for Appointing a Relay Vehicle

The distribution server 1 may determine a timing and a position for appointing a relay vehicle and instruct the distribution vehicle 2. For example, a geo-fence may be set on a scheduled travel route of the distribution vehicle 2, and the distribution vehicle 2 may be instructed to appoint a new relay vehicle when the distribution vehicle 2 enters the geo-fence. As a result, the density of the distribution vehicle 2 and the relay vehicle 4 can be made uniform over the entire area.

In the first embodiment, although the distribution vehicle 2 appoints the relay vehicle, for example, the distribution server 1 may transmit an appointment start instruction of the relay vehicle to the relay vehicle 4 and instruct the relay vehicle 4 to newly appoint another vehicle to the relay vehicle.

### Second Embodiment

In the first embodiment, the number adjustment unit is provided in the distribution server 1, but in the second embodiment, the number adjustment unit is provided in each distribution vehicle 2. In the second embodiment, a description that overlaps with the first embodiment will be omitted. The system configuration of the content distribution system 100 of the second embodiment, the hardware configuration of the distribution server 1, the distribution vehicle 2, the reception vehicle 3, and the relay vehicle 4, and the functional configuration of the distribution server 1 and the relay vehicle 4 are the same as those of the first embodiment. In the second embodiment, the in-vehicle device mounted on the distribution vehicle 2 is an example of an “information processing device”.

The functional configuration of the distribution server 1 in the second embodiment does not include the number adjustment unit 12, and the number adjustment unit 22 is included in the functional configuration of the distribution vehicle 2. When the distribution vehicle 2 is provided with the number adjustment unit 22, it is difficult for the distribution vehicle 2 to comprehensively grasp the current position of the other distribution vehicles 2 in the same area and the list of pieces of data held therein. Therefore, in the second embodiment, the number adjustment unit 22 estimates the total number of the distribution vehicles 2 and the relay vehicles 4 existing in the same area as the host vehicle based on the information obtained from the other vehicles in the inter-vehicle communication.

More specifically, the number adjustment unit 22 exchanges a list of pieces of data held in the inter-vehicle communication when the number of pieces of data is different from the other distribution vehicles 2 or the relay vehicles 4 on the road. The number adjustment unit 22 counts the distribution vehicle 2 and the relay vehicle 4 having fragment data derived from the same content and the number of times encountered E encountered during the past predetermined period with respect to each piece data held by the host vehicle. The number adjustment unit 22 estimates the total number of the distribution vehicles 2 and the relay vehicles 4 participating in the distribution of the same content in the same area as the host vehicle based on the number of times encountered E. For example, the number adjustment unit 22 assumes that the total number V (estimated value) of the distribution vehicle 2 and the relay vehicle 4 existing in the same area as the host vehicle is proportional to the number of times encountered E in the past predetermined period. The number adjustment unit 22 may estimate V using a relational expression of V=kE using a preset coefficient k. However, the method by which the number adjustment unit 22 estimates the total number of the distribution vehicles 2 and the relay vehicles 4 in the same area is not limited to this. For example, the number adjustment unit 22 may increase the accuracy of estimation of the total number of the distribution vehicles 2 and the relay vehicles 4 in the same area by using a more complicated regression equation, using a machine learning model, or the like.

Otherwise, similarly to the number adjustment unit 12 of the first embodiment, the number adjustment unit 22 instructs the distribution control unit 21 to operate in the relay vehicle appointment mode when the total number V of the distribution vehicle 2 and the relay vehicle 4 existing in the same area as the host vehicle is less than the threshold value N. When the total number V of the distribution vehicle 2 and the relay vehicle 4 existing in the same area as the host vehicle reaches the threshold value N, the number adjustment unit 22 instructs the distribution control unit 21 to operate in the normal mode. In the second embodiment, the number adjustment unit 22 may determine the threshold value N based on, for example, the position of the area, the time period, the traffic volume of the area, the importance of the distribution content, and the like.

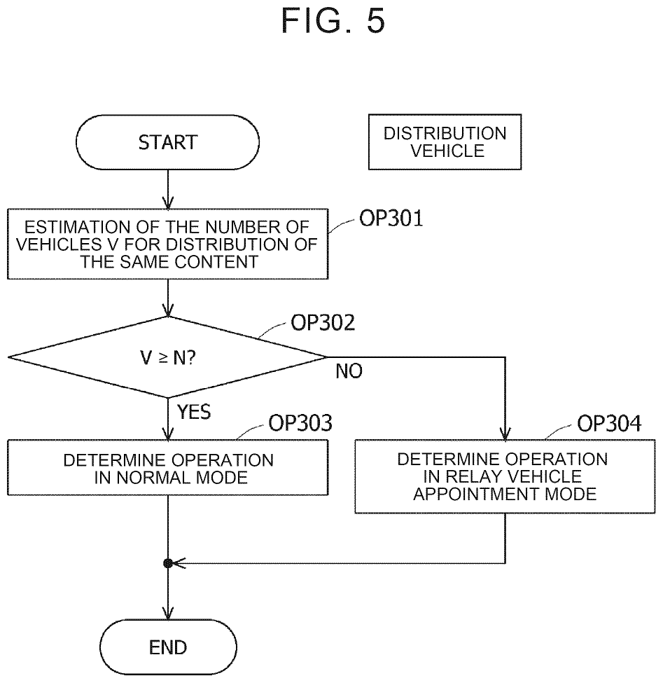

FIG. 5 is an example of a flowchart of processing performed by the number adjustment unit 22 of the distribution vehicle 2 according to the second embodiment. The processing shown in FIG. 5, while the distribution vehicle 2 holds the distribution content, every time as other distribution vehicle 2 or relay vehicle 4, or at a predetermined cycle, is performed. Further, the processing illustrated in FIG. 5 is executed for each piece of fragment data held by the distribution vehicle 2 or content derived from each piece of fragment data held by the distribution vehicle 2.

In OP301, the number adjustment unit 22 estimates the total number V of the distribution vehicles 2 and the relay vehicles 4 participating in the distribution of the same contents in the same area as the host vehicle. In OP302, the number adjustment unit 22 determines whether or not the total number V of the distribution vehicles 2 and the relay vehicles 4 participating in the distribution of the same content in the same area as the host vehicle is equal to or greater than the threshold value N. When the total number V of the distribution vehicle 2 and the relay vehicle 4 is equal to or larger than the threshold value N (OP302: YES), the process proceeds to OP303. In OP303, the number adjustment unit 22 determines the operation of the distribution control unit 21 in the normal mode and instructs the distribution control unit 21 to perform the operation. In the normal mode, the distribution control unit 21 transmits the fragment data to the reception vehicle 3 in the inter-vehicle communication when passing through the reception vehicle 3. After that, the processing shown in FIG. 5 is terminated.

When the total number V of the distribution vehicle 2 and the relay vehicle 4 is less than the threshold value N (OP302: NO), the process proceeds to OP304. In OP304, the number adjustment unit 22 determines the operation of the distribution control unit 21 in the relay-vehicle appointment mode according to the second embodiment, and instructs the distribution control unit 21 to perform the operation. After that, the processing shown in FIG. 5 is terminated.

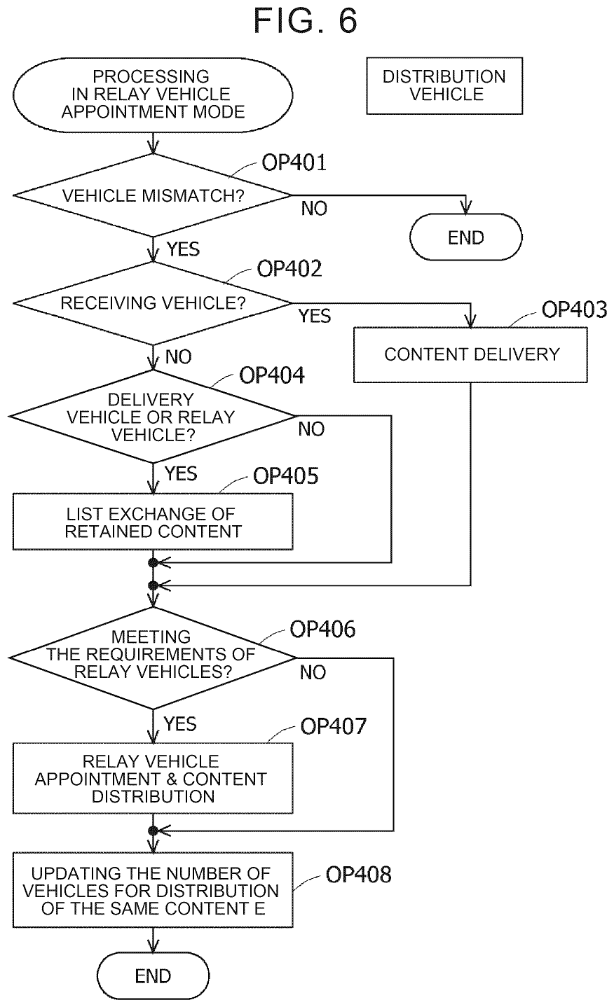

FIG. 6 is an example of a flowchart of processing in the relay vehicle appointment mode performed by the distribution control unit 21 of the distribution vehicle 2 according to the second embodiment. The processing illustrated in FIG. 6 is repeatedly executed while the distribution control unit 21 is operating in the relay vehicle appointment mode.

In OP401, the distribution control unit 21 determines whether or not it has passed other vehicles. If the vehicle has passed the other vehicle (OP401: YES), the process proceeds to OP402. If the vehicle has not passed other vehicles (OP401: NO), the process shown in FIG. 6 ends.

In OP402, the distribution control unit 21 determines whether or not the passing vehicle is the reception vehicle 3. If the passing vehicle is the reception vehicle 3 (OP402: YES), the process proceeds to OP403. In OP403, the distribution control unit 21 transmits the requested fragment data to the reception vehicle 3 through vehicle-to-vehicle communication. After that, the distribution control unit 21 may transmit a distribution report of the fragment data to the reception vehicle 3 to the distribution server 1. Thereafter, the process proceeds to OP406.

If the passing vehicle is not the reception vehicle 3 (OP402: NO), the process proceeds to OP404. In OP404, the distribution control unit 21 determines whether the passing vehicle is the distribution vehicle 2 or the relay vehicle 4. When the passing vehicle is the distribution vehicle 2 or the relay vehicle 4 (OP404: YES), the process proceeds to OP405. In OP405, the distribution control unit 21 exchanges a list of pieces of data held by the other distribution vehicles 2 or the relay vehicles 4 that have passed each 25 other through the inter-vehicle communication.

If the wrong vehicle is neither the reception vehicle 3, the distribution vehicle 2, nor the relay vehicle 4 (OP404: NO), the process proceeds to OP406. In OP406, the distribution control unit 21 determines whether the passing vehicle satisfies the requirement of the relay vehicle. If the passing vehicle meets the requirements of the relay vehicle (OP406: YES), the process proceeds to OP407. If the passing vehicle does not meet the requirements of the relay vehicle (OP406: NO), the process proceeds to OP408.

In OP407, the distribution control unit 21 sends to a different vehicle a notice of appointment of the intermediary vehicle and pieces of content subject to the intermediary vehicle appointment in inter-vehicle communications. In OP408, the distribution control unit 21 updates the number of times encountered E of the distribution vehicle 2 and the relay vehicle 4 participating in the distribution of the same content or the same fragment data in the same area as the host vehicle, based on the list of the fragment data held by the other distribution vehicle 2 or the relay vehicle 4 received in OP405 and the relay vehicle 4 newly designated by OP407. After that, the processing shown in FIG. 6 is terminated. Thereafter, for example, the processing of FIG. 5 is executed by the number adjustment unit 22. When the total number V of the distribution vehicle 2 and the relay vehicle 4 participating in the distribution of the same content or the same fragment data in the same area as the host vehicle reaches the threshold value N, the distribution control unit 21 switches to the operation in the normal mode, and the repetitive execution of the processing illustrated in FIG. 6 is stopped.

In the second embodiment, the distribution vehicles 2 do not need to notify the distribution server 1 of, for example, a distribution report, and the like, and thus it is possible to suppress communication overhead of cellular communication or WiFi communication.

### Third Embodiment

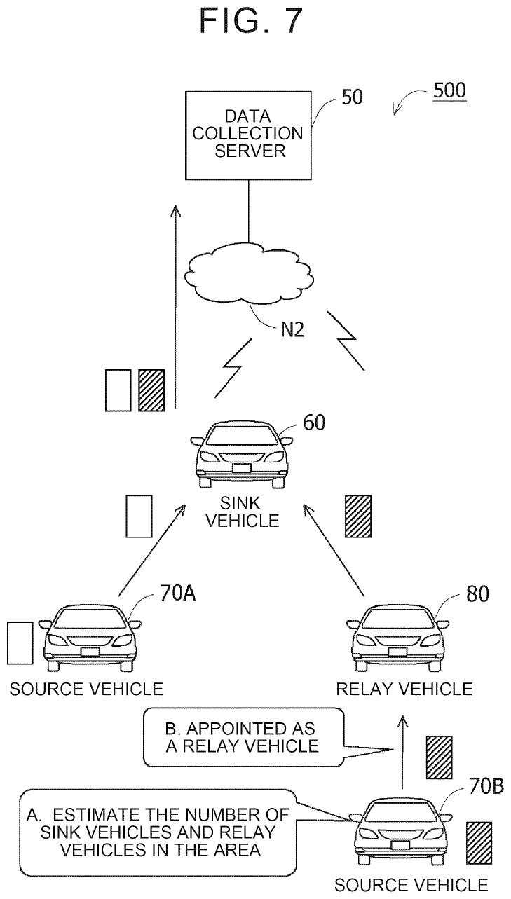

FIG. 7 is a diagram illustrating an example of a system configuration of the data collection system 500 according to the third embodiment. The data collection system 500 is a system that causes a sink vehicle to collect data generated by a source vehicle through vehicle-to-vehicle communication. An example of the data generated by the source vehicle is sensor data. Hereinafter, the data to be collected by the data collection system 500 generated by the source vehicle 70 is referred to as upload data.

The data collection system 500 includes a source vehicle 70 that generates upload data, a sink vehicle 60 that acquires upload data from the source vehicle 70 through inter-vehicle communication, and a data collection server 50 that collects upload data generated by the source vehicle 70 from the sink vehicle 60. In the third embodiment, the data collection system 500 also includes a relay vehicle 80 that relays upload data between the source vehicle 70 and the sink vehicle 60 through inter-vehicle communication. The data collection system 500 may include a plurality of the sink vehicle 60, the source vehicle 70, and the relay vehicle 80. Unless otherwise specified, the vehicle is simply referred to as a sink vehicle 60, a source vehicle 70, and a relay vehicle 80. In the following description, communication regarding each vehicle is mainly performed by each vehicle, although the actual subject is an in-vehicle device mounted on the vehicle.

The data collection server 50 and the vehicles are connected to a network N2 and can communicate with each other via a network N2. The network N2 is, for example, a public network such as the Internet. The vehicles can be connected to a network N2 via a cellular network or a radio LAN as an access network. In the second embodiment, the inter-vehicle communication may be any of, for example, inter-vehicle radio LAN communication, DSRC, or 5G sidelink communication.

First, a flow of data collection by vehicle-to-vehicle communication will be described. For example, the data collection server 50 selects a plurality of sink vehicles 60 and a plurality of source vehicles 70 from the vehicles managed by the data collection system 500 based on a predetermined policy or the like. The data collection server 50 transmits a notification of the appointment of the sink vehicle to the selected sink vehicle 60, for example, through WiFi communication or cellular communication. The data collection server 50 transmits a data collection instruction to the selected source vehicle 70. The data collection instruction includes, for example, a type of upload data generated by the source vehicle 70, an acquisition time, an acquisition frequency, a list of sink vehicles, and the like.

The source vehicle 70 generates and collects upload data in accordance with the data collection instruction, and transmits the upload data to the sink vehicle 60 through vehicle-to-vehicle communication when the upload data is passed with the designated sink vehicle 60. The sink vehicle 60 temporarily stores the upload data received from the source vehicle 70 in the storage of the in-vehicle device. For example, the sink vehicles 60 proxy transmit the temporarily stored upload data to the data collection server 50 via WiFi communication at the timing of the next connection to WiFi access point.

In the data collection system 500, when the number of the sink vehicles 60 is small in the area, the source vehicle 70 has less opportunity to transmit the upload data, and it may take time for the upload data to be collected in the data collection server 50. In the third embodiment, when the number of the sink vehicles 60 in the area is small, the number of the relay vehicles 80 that relay the upload data between the source vehicle 70 and the sink vehicle 60 is increased by appointing a vehicle that is different from the source vehicle 70 as the relay vehicle 80. This increases the chance that the source vehicle 70 will transmit the upload data. As a result, it is possible to reduce the time required for the upload data to be collected in the data collection server 50.

More specifically, it is as follows. The source vehicle 70 estimates the total number of the sink vehicle 60 and the relay vehicle 80 in the area where the host vehicle is located. The method of estimating the total number of the sink vehicle 60 and the relay vehicle 80 is the same as, for example, the method of estimating the total number of the distribution vehicle 2 and the relay vehicle 4 in the second embodiment.

When the estimated value of the total number of the sink vehicle 60 and the relay vehicle 80 in the area is less than the threshold value N, the source vehicle 70 determines to increase the relay vehicle 80. The source vehicle 70 transmits the notification of the appointment of the relay device and the upload data to the passing vehicle by the inter-vehicle communication, and appoints the notification to the relay vehicle 80. When passing through the sink vehicle 60, the relay vehicle 80 transmits upload data by vehicle-to-vehicle communication. Accordingly, since the number of vehicles transmitting the upload data to the sink vehicle 60 increases, the upload data of the source vehicle 70 is transmitted to the sink vehicle 60 passing through the relay vehicle 80 even if the chance of the source vehicle 70 passing through the sink vehicle 60 is small. Therefore, it is possible to shorten the time required for the upload data to reach the data collection server 50.

Upload data is an example of a “data block”. The source vehicle 70 is an example of a “first moving object”. The sink vehicle 60 is an example of a “second moving body”. The relay vehicle 80 is an example of a “third moving body”. The inter-vehicle communication is an example of “inter-device communication”. The in-vehicle device of the source vehicle 70 is an example of an “information processing device”.

In the third embodiment, the hardware configuration of the data collection server 50 is the same as the hardware configuration of the distribution server 1 in the first embodiment (see FIG. 2). The hardware configuration of the in-vehicle device of the sink vehicle 60, the source vehicle 70, and the relay vehicle 80 is the same as that of the first embodiment (see FIG. 2).

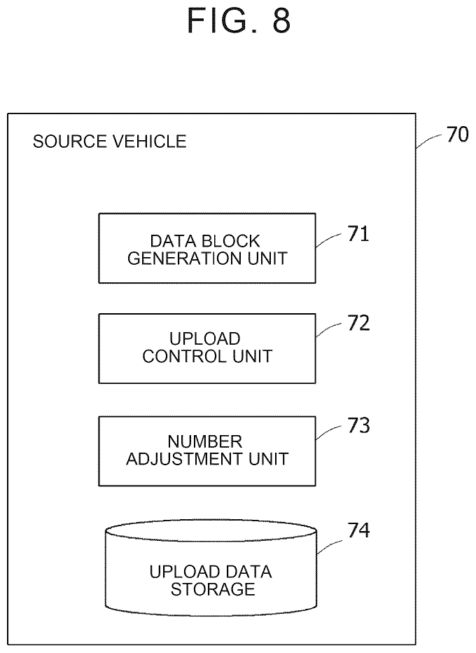

FIG. 8 is a diagram illustrating an example of a functional configuration of the source vehicle 70. The source vehicle 70 includes a data block generation unit 71, an upload control unit 72, a number adjustment unit 73, and an upload data storage unit 74 as functional configurations. The data block generation unit 71, the upload control unit 72, the number adjustment unit 73, and the upload data storage unit 74 are functional components achieved by, for example, a processor of an in-vehicle device of the source vehicle 70 executing a predetermined program.

The upload data storage unit 74 holds upload data. The upload data storage unit 74 is created in a storage area of the auxiliary storage device of the source vehicle 70. When receiving a data collection instruction from the data collection server 50, the data block generation unit 71 starts generation of upload data. The data block generation unit 71, for example, acquires the detection value from the on-board sensor, generates upload data, and stores it in the upload data storage unit 74.

The upload control unit 72 transmits the upload data, which is held in the upload data storage unit 74, to the sink vehicle 60 through the vehicle-to-vehicle communication when the difference with the sink vehicle 60. In addition, in the operation in the relay vehicle appointment mode, when the passing vehicle satisfies the requirement of the relay vehicle, the upload control unit 72 transmits the notification of the appointment of the relay vehicle and the upload data to the vehicle by the inter-vehicle communication, and appoints the vehicle to the relay vehicle 80. The requirement of the relay vehicle in the third embodiment is, for example, that the remaining amount of in-vehicle storage is equal to or greater than a predetermined threshold value, and that the relay vehicle is a sink vehicle or a relay vehicle that already has the same upload data. However, the requirement of the relay vehicle is not limited thereto.

The relay vehicle 80 stores the upload data received from the source vehicle 70 in the vehicle-to-vehicle communication in the in-vehicle storage, and transmits the upload data held in the in-vehicle storage in the vehicle-to-vehicle communication when the upload data is different from the sink vehicle 60. In addition, the upload control unit 72 may transmit, to the relay vehicle 80 or the sink vehicle 60, the upload data together with the upload data, a designated time in which the relay vehicle 80 or the sink vehicle 60 holds the upload data. The relay vehicle 80 and the sink vehicle 60 may delete the upload data from the in-vehicle storage when the specified time elapses.

The details of the processing of the upload control unit 72 are the same as the processing in the case where, for example, the reception vehicle 3 is replaced with the sink vehicle 60, the distribution vehicle 2 is replaced with the source vehicle 70, the relay vehicle 4 is replaced with the relay vehicle 80, and the content is replaced with the upload data in FIG. 6, which is the processing of the distribution control unit 21 of the distribution vehicle 2 in the second embodiment.

The number adjustment unit 73 replaces the distribution vehicle 2 in the second embodiment with the sink vehicle 60 and the relay vehicle 4 with the relay vehicle 80, and estimates the total number V of the sink vehicle 60 and the relay vehicle 80 in the same area based on the number of encounters with the sink vehicle 60 or the relay vehicle 80 in the same manner as the number adjustment unit 22 of the distribution vehicle 2 in the second embodiment. In addition, when the total number V of the sink vehicle 60 and the relay vehicle 80 in the same area is less than the threshold value N, the number adjustment unit 73 determines the operation of the upload control unit 72 in the relay vehicle appointment mode and instructs the upload control unit 72. When the total number V of the sink vehicle 60 and the relay vehicle 80 in the same area reaches the threshold value N, the number adjustment unit 73 determines the operation of the upload control unit 72 in the normal mode and instructs the upload control unit 72 to perform the operation. The operation of the upload control unit 72 in the normal mode is to transmit the upload data to the different sink vehicle 60 through the inter-vehicle communication.

According to the third embodiment, even in the data collection system 500 in which the data flow is in the upload direction, the number of relay vehicles 80 that relay the upload data between the source vehicle 70 and the sink vehicle 60 can be adjusted in the same manner as the content distribution system 100 in which the data flow is in the download direction.

As a modification of the third embodiment, a system in which the number adjustment unit is provided in the data collection server 50 instead of the source vehicle 70 is exemplified. A number adjustment unit may be provided in the data collection server 50. In this case, similarly to the first embodiment, the source vehicle 70 and the relay vehicle 80 transmit, to the data collection server 50, a report indicating that the upload data has been transmitted to the sink vehicle 60, a list of the location information and the upload data to be held, and the like at a predetermined cycle or when a predetermined event occurs. The data collection server 50 acquires the total number of the sink vehicles 60 and the relay vehicles 80 in each area based on the communication history information with the source vehicles 70 and the relay vehicles 80. If it is less than the threshold value N, the data collection server 50 transmits an appointment start instruction of the relay vehicle to the source vehicle 70 in order to increase the relay vehicle 80. When the total number of the sink vehicles 60 and the relay vehicles 80 in each area reaches the threshold value N, the data collection server 50 transmits an appointment stop instruction of the relay vehicle to the source vehicle 70.

### Other Embodiments

The above-described embodiment is merely an example, and the present disclosure may be appropriately modified and implemented without departing from the scope thereof.

The processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. A Non-transitory computer-readable storage media include any type of media suitable for storing electronic instructions, for example, magnetic disks (floppy (registered trademark) disks, Hard Disk Drive (HDD), etc.), optical disks (CD-ROM, DVD disks, Blu-ray disks, etc.), any type of disks, Read Only Memory (ROM), Random Access Memory (RAM), EPROM, EEPROM, magnetic cards, flash memories, optical cards.

What is claimed is:

1. An information processing device comprising a control unit configured to
acquire a total number of second mobile bodies and third mobile bodies within a predetermined area, the second mobile bodies relaying a data block between a first mobile body and a predetermined server through device-to-device communication with the first mobile body and through first wireless communication with the predetermined server, and the third mobile bodies relaying the data block between the first mobile body and the second mobile bodies through the device-to-device communication, and
when the total number is less than a predetermined threshold value, instruct either the second mobile bodies or the first mobile body to appoint a different mobile body as a third mobile body by transmitting the data block to the different mobile body through the device-to-device communication.

2. The information processing device according to claim 1, wherein the control unit is further configured to determine the predetermined threshold value based on at least one of a position of the predetermined area, a time zone, and a traffic volume.

3. The information processing device according to claim 1, wherein the control unit is further configured to
acquire position information from a plurality of mobile bodies positioned within the predetermined area,
receive a first notification that the different mobile body has been appointed as the third mobile body from either the second mobile bodies or the first mobile body, and
acquire a total number of the second mobile bodies and the third mobile bodies within the predetermined area based on the first notification and the position information on the second mobile bodies and the third mobile bodies.

4. The information processing device according to claim 1, wherein:
the information processing device is mounted on a second mobile body; and
the control unit is further configured to
exchange a list of data blocks that are held with one or more other second mobile bodies or one or more of the third mobile bodies through the device-to-device communication, and
estimate a total number of the second mobile bodies and the third mobile bodies within the predetermined area for the data blocks based on one or more lists obtained through the exchanging.

5. A non-transitory storage medium storing a program that causes a computer to execute a process comprising:
acquiring a total number of second mobile bodies and third mobile bodies within a predetermined area, the second mobile bodies relaying a data block between a first mobile body and a predetermined server through device-to-device communication with the first mobile body and through first wireless communication with the predetermined server, and the third mobile bodies relaying the data block between the first mobile body and the second mobile bodies through the device-to-device communication; and
when the total number is less than a predetermined threshold value, instructing either the second mobile bodies or the first mobile body to appoint a different mobile body as a third mobile body by transmitting the data block to the different mobile body through the device-to-device communication.
